(19) United States
(12) Patent Application Publication
(10) Pub. No.: US 2024/0270909 A1
(43) Pub. Date: Aug. 15, 2024

(54) MULTIMODULUS SILICONE RESINS BASED ON THIOL-ENE-EPOXY CHEMISTRIES

(71) Applicant: Meta Platforms Technologies, LLC, Menlo Park, CA (US)

(72) Inventors: Thomas John Farrell Wallin, Redmond, WA (US); Steven Adelmund, Seattle, WA (US); Wenyang Pan, Redmond, WA (US); Chi Chung Li, Redmond, WA (US)

(21) Appl. No.: 18/438,232

(22) Filed: Feb. 9, 2024

Related U.S. Application Data
(60) Provisional application No. 63/484,443, filed on Feb. 10, 2023.

(51) Int. Cl. C08G 77/06; C08G 77/14; C08G 77/20; C08G 77/28

(52) U.S. Cl. CPC C08G 77/06; C08G 77/14; C08G 77/20; C08G 77/28

(57) ABSTRACT

The disclosure provides methods of generating a modulus gradient in a polymeric silicone material, resin mixtures for such methods, and polymeric silicone materials thereof having at least a modulus gradient.

### CROSS-REFERENCE TO RELATED PATENT APPLICATION

The present application claims priority to U.S. Provisional Patent Application No. 63/484,443, entitled “Multimodulus Silicone Resins Based On Thiol-Ene-Epoxy Chemistries,” filed Feb. 10, 2023, which is hereby incorporated by reference in its entirety.

### TECHNICAL FIELD

Polymers having a modulus gradient and methods of making thereof are provided, including specific resin mixtures and sequences of applying polymerization and/or crosslinking stimuli.

### BACKGROUND

Conventional resin exchange methods or other means that control the deposition of liquid precursor can allow for multi-material fabrication. However, these techniques require multiple resin stocks and cleaning steps, which drastically reduce manufacturing speeds. The art has explored the methodology needed to construct two-stage polymers and their potential application in shape memory materials, holographic materials, impression and imprint materials, microarrays, adhesives, etc. However, typical sequential polymerizations usually utilize either a single photo trigger (at a certain wavelength) or a combined thermal/photo trigger to control the network formation using two crosslinking reactions. Currently, there are a few examples of N=2 photochemistry systems that can coexist within the same material, including light intensity controlled multimaterials and wavelength-selective polymerization processes; but these examples suffer from many drawbacks, including that the resulting material is not stable under sunlight, and/or that the resulting material has a gradient of 1-4 orders of magnitude difference in modulus. The disclosure provides materials, methods, and processes to overcome these drawbacks.

### SUMMARY

The disclosure provides a silicone material having a modulus gradient over one spatial direction, wherein modulus is measured in a plurality of voxels, the material comprising a partially or fully polymerized or crosslinked silicone resin. In some embodiments, the modulus is selected from Young's modulus (E), shear modulus or modulus of rigidity (G), and bulk modulus (K). In some embodiments, the modulus is Young's modulus (E). In some embodiments, the modulus is storage modulus and/or loss modulus. In some embodiments, the modulus ranges from about 10²to about 10¹⁰ Pa. In some embodiments, the modulus ranges from about 10³to about 10⁷ Pa. In some embodiments, the modulus ranges from about 10⁵to about 10¹⁰ Pa. In some embodiments, the silicone material comprises a polymer backbone comprising a group selected from —Si(CH₃)₂—, —O—Si(CH₃)₂—, and —O—(CH₂)ₙ−, wherein n is integer from 1 to 3, from 4 to 6, or from 7 to 12. In some embodiments, the silicone resin comprises a polymer backbone comprising a group selected from —Si(CH₃)₂—, —O—Si(CH₃)₂—, and —O—(CH₂)ₙ—, wherein n is integer from 1 to 3, from 4 to 6, or from 7 to 12. In some embodiments, the silicone resin prior to polymerization and/or crosslinking comprises three different polymerizable or crosslinkable moieties. In some embodiments, the stoichiometric ratio of three different polymerizable or crosslinkable moieties is 1:X:Y, wherein X<1, and X+Y≥1. In some embodiments, the three different polymerizable or crosslinkable moieties are an alkene group, a thiol group, and an epoxy group. In some embodiments, the stoichiometric ratio of thiol groups to alkene groups to epoxy groups is 1:X:Y, wherein X<1, and X+Y≥1. In some embodiments, (1−X)≤Y≤2, or 1≤Y≤2. In some embodiments, the silicone resin comprises a multifunctional vinyl or ene silicone, a multifunctional epoxide silicone, and a multifunctional thiol silicone. In some embodiments, the multifunctional vinyl or ene silicone has a functionality between about 4 and about 500. In some embodiments, the multifunctional epoxide silicone has a functionality between about 1.9 and about 4. In some embodiments, the multifunctional thiol silicone has a functionality between about 1.9 and about 4. In some embodiments, the silicone resin comprises a multifunctional vinyl or ene silicone, a diepoxide silicone, and a dithiol silicone.

In some embodiments, the multifunctional vinyl silicone is selected from VDT5035, VDT-954, VDT-731, VDT-431, and VMS-T11. In some embodiments, the diepoxide silicone is selected from DMS-E09, DMS-E11, DMS-E12, DMS-E21, EP-J10, and combinations thereof. In some embodiments, the dithiol silicone is selected from X-22-167C, X-22-167B, SMS-042, mercaptopropyl terminated polydimethylsiloxane, and 3-[(dimethyl-3-(sulfanylpropyl)silyl)oxy-dimethylsilyl]propane-1-thiol. In some embodiments, the silicone material comprises at least one group selected from —S—, —S—CH₂—CH₂—, —S—CH₂—CH(OH)—, —CH₂—CH(−)—O—, and —CH₂—CH(−)—O—CH₂—CH(OH)—. In some embodiments, the silicone material comprises a thiol-vinyl or thiol-ene adduct moiety, a thiol-epoxy adduct moiety, an alcohol-epoxy adduct moiety, and/or an epoxy-epoxy adduct moiety. In some embodiments, the stoichiometric ratio of thiol-vinyl or thiol-ene adduct moieties to thiol-epoxy adduct moieties is X:(1-X), wherein X<1. In some embodiments, the stoichiometric ratio of thiol-vinyl adduct moieties or thiol-ene adduct moieties to thiol-epoxy adduct moieties to alcohol-epoxy adduct moieties and/or epoxy-epoxy adduct moieties is X:(1−X):(Y−(1−X)), wherein X<1, and X+Y≥1. In some embodiments, (1−X)≤Y≤2, or (1−X)≤Y≤2, or 1≤Y≤2. In some embodiments, the silicone resin further comprises a photoinitiator and/or a thermal initiator. In some embodiments, the silicone material is 3D printed.

The disclosure also provides a method of generating a modulus gradient in a silicone material, the method comprising: subjecting an initial precursor silicone resin mixture to a first polymerization and/or crosslinking stimulus, wherein the initial precursor silicone resin mixture comprises a plurality of monomers, polymers, or oligomers comprising at least three different polymerizable or crosslinkable moieties, wherein the at least three different polymerizable or crosslinkable moieties are selected from an alkene group, a thiol group, and an epoxy group, generating an intermediate silicone resin mixture, and subjecting the intermediate silicone resin mixture to a second polymerization and/or crosslinking stimulus. In some embodiments, the stoichiometric ratio of thiol groups to alkene groups to epoxy groups in the initial precursor silicone resin mixture is 1:X:Y, wherein X<1, and X+Y≥1. In some embodiments, (1−X)≤Y≤2, or 1≤Y≤2. In some embodiments, the intermediate silicone resin mixture is partially crosslinked or polymerized. In some embodiments, the intermediate silicone resin mixture comprises at least one group selected from —S—, —CH₂—CH₂—, and —S—CH₂—CH₂—. In some embodiments, the silicone material comprises at least one group selected from —S—, —S—CH₂—CH₂—, —S—CH₂—CH(OH)—, —CH₂—CH(−)—O—, and —CH₂—CH(−)—O—CH₂—CH(OH)—. In some embodiments, the silicone material comprises a thiol-vinyl or thiol-ene adduct moiety, a thiol-epoxy adduct moiety, and an alcohol-epoxy or epoxy-epoxy adduct moiety. In some embodiments, the stoichiometric ratio of thiol-vinyl or thiol-ene adduct moieties to thiol-epoxy adduct moieties is X:(1−X), wherein X<1. In some embodiments, the stoichiometric ratio of thiol-vinyl adduct moieties or thiol-ene adduct moieties to thiol-epoxy adduct moieties to alcohol-epoxy adduct moieties and/or epoxy-epoxy adduct moieties is X:(1−X):(Y−(1−X)), wherein X<1, and X+Y≥1. In some embodiments, (1−X)≤Y≤2, or 1≤Y≤2. In some embodiments, the monomer, polymer, and/or oligomer is selected from a monofunctional monomer, polymer, and/or oligomer, a bifunctional monomer, polymer, and/or oligomer, a trifunctional monomer, polymer, and/or oligomer, and a tetrafunctional monomer, polymer, and/or oligomer. In some embodiments, the monomer, polymer, and/or oligomer are selected from a multifunctional vinyl silicone, a diepoxide silicone, and a dithiol silicone. In some embodiments, the multifunctional vinyl silicone is selected from VDT-5035, VDT-954, VDT-731, VDT-431, and VMS-T11. In some embodiments, the diepoxide silicone is selected from DMS-E09, DMS-E11, DMS-E12, DMS-E21, EP-J10, and combinations thereof. In some embodiments, the dithiol silicone is selected from X-22-167C, X-22-167B, SMS-042, mercaptopropyl terminated polydimethylsiloxane, and 3-[(dimethyl-3-(sulfanylpropyl)silyl)oxy-dimethylsilyl]propane-1-thiol. In some embodiments, the first and/or second polymerization and/or crosslinking stimulus is selected from subjecting the initial precursor silicone resin mixture and/or any of the intermediate silicone resin mixtures to a light source and/or a raised temperature. In some embodiments, the first polymerization and/or crosslinking stimulus is subjecting the initial precursor silicone resin mixture to a light source. In some embodiments, the second polymerization and/or crosslinking stimulus is selected from subjecting any of the intermediate silicone resin mixtures to a first raised temperature above room temperature. In some embodiments, the method further comprising subjecting any of the intermediate silicone resin mixtures to a second raised temperature above room temperature. In some embodiments, a first raised temperature above room temperature is between about 75° C. and about 150° C. In some embodiments, a first raised temperature above room temperature is between about 90° C. and about 120° C. In some embodiments, a second raised temperature above room temperature is between about 125° C. and about 200° C. In some embodiments, a second raised temperature above room temperature is between about 150° C. and about 170° C. In some embodiments, the initial precursor silicone resin mixture further comprises a photoinitiator and/or a thermal initiator. In some embodiments, the modulus is selected from Young's modulus (E), shear modulus or modulus of rigidity (G), and bulk modulus (K). In some embodiments, the modulus is storage modulus and/or loss modulus. In some embodiments, the method is a 3D printing method. In some embodiments, a first portion of the precursor resin is exposed to the first polymerization and/or crosslinking stimulus, and a second portion of the precursor resin is shielded from the first polymerization and/or crosslinking stimulus. In some embodiments, a first portion of the precursor resin is exposed to a first dosage of the first polymerization and/or crosslinking stimulus, and a second portion of the precursor resin is exposed to a second dosage of the first polymerization and/or crosslinking stimulus, wherein the first dosage and the second dosage are different.

The disclosure also provides a silicone material having at least one modulus gradient in a spatial direction, the silicone material made by a method disclosed herein.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures and specification.

FIG. 1 illustrates several exemplary formulas for a multifunctional vinyl silicone, a diepoxide silicone, and a dithiol silicone.

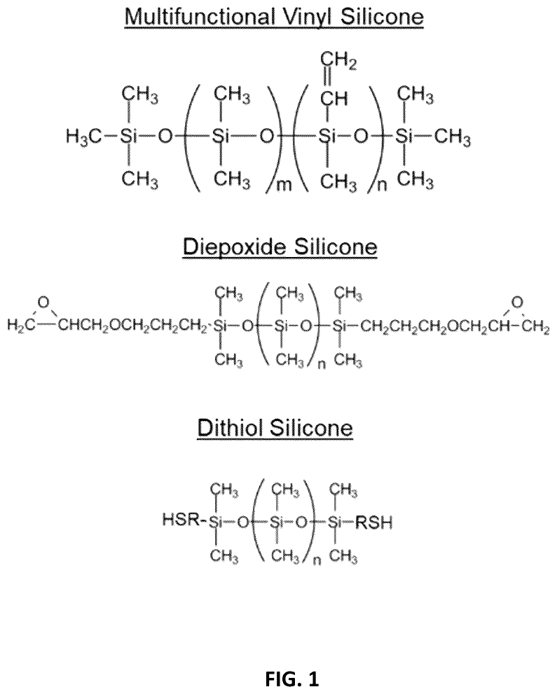

FIG. 2 illustrates exemplary embodiments of implementing methods disclosed herein. In some embodiments, a photopattern can be employed in order to expose only certain areas of a precursor resin to a light stimulus, or in order to expose different areas of the precursor resin to different dosages of a light stimulus. Upon completion of the polymerization or crosslinking process via exposure to raised temperature stimuli, the resulting material will exhibit a gradient of modulus, e.g., will have softer regions and stiffer regions. The stiffer regions could be for example be used for affixing electronic components, while the softer regions would allow the material to be exposed to strain.

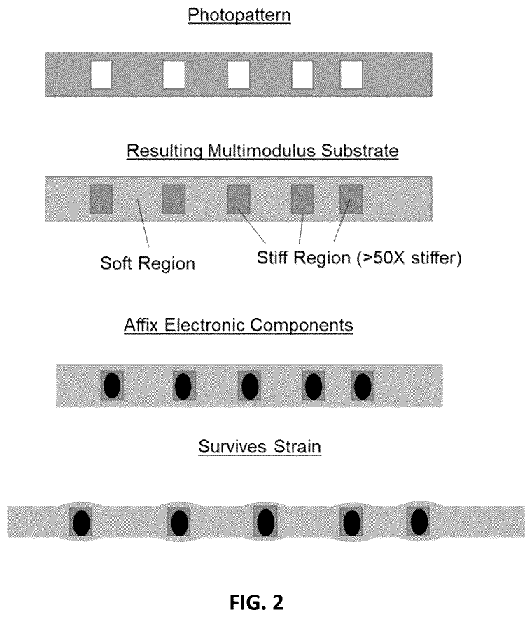

### DETAILED DESCRIPTION

Many applications would benefit from the ability to locally pattern the mechanical response to deformation. Such applications include soft robots, haptic displays, electronics substrates and packaging, and biomedical devices. Silicones are a polymer class suitable for these applications owing to their biocompatibility, high elasticity, as well as chemical and thermal resistance; however, there are currently no ways to pattern continuous mechanical gradients that are stable in silicone. The next best method would be to assemble discrete steps of silicones with different moduli, but issues regarding mass deposition at a sub-millimeter scale and strong interfacial bonding between different materials inhibits this approach.

Methods to pattern continuous mechanical gradients in other polymeric materials (see, e.g., Kuang et al., Sci. Adv. 2019, 5: eaav5790.) involve altering the stiffness by simultaneously modulating the polymer's local glass transition temperatures (Tg). At temperatures well above or below the Tg range (e.g., ±50° C.), the modulus ratio (E_{stiff}/E_{soft}) can substantially decrease, limiting the performance of the material in environments that are not thermally controlled.

The disclosure provides, in part, multimodulus silicone resin materials with stable mechanical performance in variable temperature environments (e.g., above 50° C.).

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Unless defined otherwise, all technical and scientific terms used herein have the same meaning as is commonly understood by one of skill in the art to which this disclosure belongs. All patents and publications referred to herein are incorporated by reference in their entireties.

When ranges are used herein to describe, for example, physical or chemical properties such as molecular weight or chemical formulae, all combinations and subcombinations of ranges and specific embodiments therein are intended to be included. Use of the term “about” when referring to a number or a numerical range means that the number or numerical range referred to is an approximation within experimental variability (or within statistical experimental error), and thus the number or numerical range may vary. The variation is typically from 0% to 15%, or from 0% to 10%, or from 0% to 5% of the stated number or numerical range. The term “including” (and related terms such as “comprise” or “comprises” or “having” or “including”) includes those embodiments such as, for example, an embodiment of any composition of matter, method or process that “consist of” or “consist essentially of” the described features.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” means “when” or “upon” or “in response to determining” or “in response to detecting” or “in accordance with a determination that,” depending on the context. Similarly, the phrase “if it is determined” or “if [a stated condition or event] is detected” means “upon determining” or “in response to determining” or “upon detecting [the stated condition or event]” or “in response to detecting [the stated condition or event]” or “in accordance with a determination that [a stated condition or event] is detected,” depending on the context.

The term “light source” refers to any source of electromagnetic radiation of any wavelength, including without limitation an actinic radiation. In some embodiments, a light source can be a laser of a particular wavelength.

The term “photoinitiating light source” refers to a light source that activates a photoinitiator, a photoactive polymerizable material, or both. Photoinitiating light sources include recording light, but are not so limited.

The term “photopolymerization” refers to any polymerization reaction caused by exposure to a photoinitiating light source.

The term “free radical polymerization” refers to any polymerization reaction that is initiated by any molecule comprising a free radical or radicals.

The term “cationic polymerization” refers to any polymerization reaction that is initiated by any molecule comprising a cationic moiety or moieties.

The term “anionic polymerization” refers to any polymerization reaction that is initiated by any molecule comprising an anionic moiety or moieties.

The term “photoinitiator” refers to the conventional meaning of the term photoinitiator and also refers to sensitizers and dyes. In general, a photoinitiator causes the light initiated polymerization of a material, such as a photoactive oligomer or monomer, when the material containing the photoinitiator is exposed to light of a wavelength that activates the photoinitiator, e.g., a photoinitiating light source. The photoinitiator may refer to a combination of components, some of which individually are not light sensitive, yet in combination are capable of curing the photoactive oligomer or monomer, examples of which include a dye/amine, a sensitizer/iodonium salt, a dye/borate salt, etc.

The term “photoinitiator component” refers to a single photoinitiator or a combination of two or more photoinitiators. For example, two or more photoinitiators may be used in the photoinitiator component of the present disclosure to allow recording at two or more different wavelengths of light.

The term “polymerizable component” refers to one or more photoactive polymerizable materials, and possibly one or more additional polymerizable materials, e.g., monomers and/or oligomers, that are capable of forming a polymer.

The term “polymerizable moiety” refers to a chemical group capable of participating in a polymerization reaction, at any level, for example, initiation, propagation, etc. Polymerizable moieties include, but are not limited to, addition polymerizable moieties and condensation polymerizable moieties. Polymerizable moieties include, but are not limited to, double bonds, triple bonds, and the like.

The term “photoactive polymerizable material” refers to a monomer, an oligomer and combinations thereof that polymerize in the presence of a photoinitiator that has been activated by being exposed to a photoinitiating light source, e.g., recording light. In reference to the functional group that undergoes curing, the photoactive polymerizable material comprises at least one such functional group. It is also understood that there exist photoactive polymerizable materials that are also photoinitiators, such as N-methylmaleimide, derivatized acetophenones, etc., and that in such a case, it is understood that the photoactive monomer and/or oligomer of the present disclosure may also be a photoinitiator.

The term “photopolymer” refers to a polymer formed by one or more photoactive polymerizable materials, and possibly one or more additional monomers and/or oligomers.

The term “polymerization retarder” refers to one or more compositions, compounds, molecules, etc., that are capable of slowing, reducing, etc., the rate of polymerization while the photoinitiating light source is off or absent, or inhibiting the polymerization of the polymerizable component when the photoinitiating light source is off or absent. A polymerization retarder is typically slow to react with a radical (compared to an inhibitor), thus while the photoinitiating light source is on, polymerization continues at a reduced rate because some of the radicals are effectively terminated by the retarder. In some embodiments, at high enough concentrations, a polymerization retarder can potentially behave as a polymerization inhibitor. In some embodiments, it is desirable to be within the concentration range that allows for retardation of polymerization to occur, rather than inhibition of polymerization.

The term “polymerization inhibitor” refers to one or more compositions, compounds, molecules, etc., that are capable of inhibiting or substantially inhibiting the polymerization of the polymerizable component when the photoinitiating light source is on or off. Polymerization inhibitors typically react very quickly with radicals and effectively stop a polymerization reaction. Inhibitors cause an inhibition time during which little to no photopolymer forms, e.g., only very small chains. Typically, photopolymerization occurs only after nearly 100% of the inhibitor is reacted.

The term “chain transfer agent” refers to one or more compositions, compounds, molecules, etc. that are capable of interrupting the growth of a polymeric molecular chain by formation of a new radical that may react as a new nucleus for forming a new polymeric molecular chain. Typically, chain transfer agents cause the formation of a higher proportion of shorter polymer chains, relative to polymerization reactions that occur in the absence of chain transfer agents. In some embodiments, certain chain transfer agents can behave as retarders or inhibitors if they do not efficiently reinitiate polymerization.

Unless otherwise stated, the chemical structures depicted herein are intended to include compounds which differ only in the presence of one or more isotopically enriched atoms. For example, compounds where one or more hydrogen atoms is replaced by deuterium or tritium, or where one or more carbon atoms is replaced by ¹³C- or ¹⁴C-enriched carbons, are within the scope of this disclosure.

An “alkene” moiety refers to a group consisting of at least two carbon atoms and at least one carbon-carbon double bond, and an “alkyne” moiety refers to a group consisting of at least two carbon atoms and at least one carbon-carbon triple bond. “Alkenyl” refers to a straight or branched hydrocarbon chain radical group consisting solely of carbon and hydrogen atoms, containing at least one double bond, and having from two to ten carbon atoms (e.g., (C₂₋₁₀)alkenyl or C₂₋₁₀ alkenyl). Whenever it appears herein, a numerical range such as “2 to 10” refers to each integer in the given range-e.g., “2 to 10 carbon atoms” means that the alkenyl group may consist of 2 carbon atoms, 3 carbon atoms, etc., up to and including 10 carbon atoms. The alkenyl moiety may be attached to the rest of the molecule by a single bond, such as for example, ethenyl (e.g., vinyl), prop-1-enyl (e.g., allyl), but-1-enyl, pent-1-enyl and penta-1,4-dienyl. Unless stated otherwise specifically in the specification, an alkenyl group is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl —-OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a}(where t is 1 or 2), —S(O)ₜR^{a}(where t is 1 or 2), —S(O)ₜ OR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Moiety” refers to a specific segment or functional group of a molecule. Chemical moieties are often recognized chemical entities embedded in or appended to a molecule.

“Substituted” means that the referenced group may have attached one or more additional groups, radicals or moieties individually and independently selected from, for example, acyl, alkyl, alkylaryl, cycloalkyl, aralkyl, aryl, carbohydrate, carbonate, heteroaryl, heterocycloalkyl, hydroxy, alkoxy, aryloxy, mercapto, alkylthio, arylthio, cyano, halo, carbonyl, ester, thiocarbonyl, isocyanato, thiocyanato, isothiocyanato, nitro, oxo, perhaloalkyl, perfluoroalkyl, phosphate, silyl, sulfinyl, sulfonyl, sulfonamidyl, sulfoxyl, sulfonate, urea, and amino, including mono-and di-substituted amino groups, and protected derivatives thereof. The substituents themselves may be substituted, for example, a cycloalkyl substituent may itself have a halide substituent at one or more of its ring carbons. The term “optionally substituted” means optional substitution with the specified groups, radicals or moieties.

Compounds of the present disclosure also include crystalline and amorphous forms of those compounds, including, for example, polymorphs, pseudopolymorphs, solvates, hydrates, unsolvated polymorphs (including anhydrates), conformational polymorphs, and amorphous forms of the compounds, as well as mixtures thereof. “Crystalline form” and “polymorph” are intended to include all crystalline and amorphous forms of the compound, including, for example, polymorphs, pseudopolymorphs, solvates, hydrates, unsolvated polymorphs (including anhydrates), conformational polymorphs, and amorphous forms, as well as mixtures thereof, unless a particular crystalline or amorphous form is referred to.

For the avoidance of doubt, it is intended herein that particular features (for example integers, characteristics, values, uses, formulae, compounds or groups) described in conjunction with a particular aspect, embodiment or example of the disclosure are to be understood as applicable to any other aspect, embodiment or example described herein unless incompatible therewith. Thus, such features may be used where appropriate in conjunction with any of the definition, claims or embodiments defined herein. All of the features disclosed in this specification (including any accompanying claims, abstract and drawings), and/or all of the steps of any method or process so disclosed, may be combined in any combination, except combinations where at least some of the features and/or steps are mutually exclusive. The present disclosure is not restricted to any details of any disclosed embodiments.

Photolithographic techniques (including 3D printing) offer excellent spatial and temporal resolution when building polymeric objects from liquid components. However, obtaining a diverse set of material properties (optical, electrical, mechanical, etc.) from such techniques remains a challenge. Moreover, materials with smooth gradients of properties from stiff to soft have not been achieved in the past. As such, the disclosure provides methods of patterning different regions of material (N>2) by varying the photodosage incident on a single resin precursor. This multi-material framework, which is based, at least in part and without limitation, on three orthogonal crosslinking reactions, enables the multi-material 3D printing of materials with different Young's modulus and surface energy, and is useful for adhesive, coating, and additive manufacturing.

3D printing techniques based on vat photopolymerization (stereolithography [SLA], continuous liquid interface production [CLIP], Solution Mask Liquid Lithography [SMaLL], holographic and/or tomographic printing, etc.) are particularly attractive for fabricating complex polymeric structures. Though distinctions exist among the different technologies, in general, vat photopolymerization relies on the photoirradiation of a container of liquid photopolymer resin to build a solid object. The buoyant support provided by the resin enables high aspect ratio features of compliant structures with minimal deflection during printing. Further, these processes benefit from the spatial-temporal resolution of light; the scalability of projected photopatterns enables rapid build speeds without a loss in resolution. Despite these advantages, most of current materials and techniques employed for 3D printing are limited to the fabrication of material with single mechanical performance, while multimaterial with voxelated controlled mechanical behaviors can open many new possibilities that are not accessible with other technologies. For example, voxelated controlled multimaterial can ensure optimum strength and maximum flaw tolerance. However, 3D printing of multimaterial with vat polymerization can be problematic. A straightforward method for obtaining discrete material regions in a single printed object is to use vat replacement techniques. Yet, each resin needs its own material stock and avoiding cross-contamination requires additional cleaning steps. Unfortunately, resin-replacement strategies remain incongruous with volumetric printing which rapidly builds monolithic parts during a single exposure.

Novel photochemistries that enable varying material properties from within a single resin chemistry overcome this limitation and maintain rapid multimaterial print speeds. Recent works precisely control the photoexposure dosage in materials based on (meth)acrylate homopolymerization to create smooth gradients for soft robotic actuators. However, these stiffness gradients are relatively shallow (Young's Modulus, E ˜2-15 kPa) and unstable due to the continued of polymerization of unreacted monomers. Multicomponent resins that possess orthogonal photochemical reactions yield binary materials with discrete variations in stiffness (E_{hard}/E_{soft} ˜10-10⁴). As disclosed herein however, the crosslinking reactions initiate in response to different stimuli (multiple wavelengths or light and heat) to allow for localization of desired properties. Known multimaterial photochemistries include the cationic polymerization of epoxy (λ=365 nm) with free radical polymerization of acrylates (λ=405 nm), or the anionic thiol-Michael addition (λ=400-500 nm) with radical polymerization of acrylates (λ=365 nm). 3D printing such chemistries often requires additional considerations—the use of custom printers with multiple light sources and/or the addition of photochromic species to accentuate subtle absorption differences between photoinitiators that possess broad overlapping spectra. As an alternative, it was previously shown a novel dual-stage curing hybrid ink combining acrylate homopolymerization with aza-Michael reaction to achieve the single-vat grayscale DLP 4D printing.

However, all of these strategies result in materials of questionable stability. Specifically, the “soft” regions within these systems are intentionally “underpolymerized.” These voxels contain unreacted groups that continue to crosslink and stiffen under exposure to ambient light or heat. Even without additional polymerization, such unbound species can escape the polymer network and the corresponding loss in mass may result in dimensional changes (loss of resolution) of the printed object.

This disclosure provides a multimaterial system with stable and voxel controlled mechanical properties based on three orthogonal reactions. Without wishing to be bound by any particular theory, the disclosure provides a sequential reaction scheme from compatible functional groups that participate in different polymerization mechanisms based on the applied stimulus. In some embodiments, this approach combines thiol-ene and thiol-epoxy step growth polymerizations with epoxy chain growth homopolymerization to form a polymer networks with disparate mechanical properties. By simply modulating the photoirradiation dosage, the resultant materials exhibit Young's moduli spanning three orders of magnitude (100 kPa<E_{0.2-1%}<100 MPa) with smooth transitions from soft and stiff regions. Unlike other photopatterned gradients, the full consumption of crosslinking groups imparts environmental (i.e., photo and thermal) stability to the final products described herein after processing. In some embodiments, the platform described herein is used to holographically and/or tomographically print monolithic 3D multimaterial structures including soft robotic Braille displays.

Solid polymeric materials possess long chains of macromolecules held together by sufficient interactions (i.e., physical entanglements, Van der Waal forces, electrostatic forces, hydrogen bonds, covalent bonds) between chains. In general, soft materials have weak interactions (e.g., loosely crosslinked flexible chains) while stiff materials exhibit strong interchain interactions (e.g., highly crosslinked, rigid linkages). Without wishing to be bound by any particular theory, when polymerizing a solid object from liquid precursors, reactions either add to a growing polymer backbone (increase molecular weight) or connect neighboring chains (network formation). Also without wishing to be bound by any particular theory, this distinction depends on the functionality (f), or the number of bonds a species forms during polymerization: species with f=1 are chain terminators, f=2 are chain extenders, and f>2 are crosslinkers. For a given chemistry, the functionality of the polymer building blocks and the extent of reaction (i.e., fraction of groups reacted) control the material's crosslink density and, consequently, E. For stable performance, and without wishing to be bound by any particular theory, it is assumed that all reactions will eventually approach 100% conversion. In some embodiments, the modulus can be controlled by varying the functionality of the reactants.

As described herein, the chemical design exploits the fundamental differences in stepwise addition (e.g., thiol-ene, thiol-epoxy) and chain growth (e.g., epoxy-epoxy) polymerizations. In stepwise addition, each participating chemical group reacts only once (monofunctional), often resulting in a homogeneous network. By comparison, in chain growth polymerization, each moiety forms two bonds (difunctional) and crosslinkers usually incorporate into the polymer heterogeneously. In some embodiments, a resin mixture described herein combines a multi-vinyl species, a thiol mixture in various molar ratios of di- and tetra-thiol molecules, and a diepoxy, all having a silicone backbone. This composition creates a three-stage curing chemistry: two stepwise addition reactions (thiol-ene and thiol-epoxy polymerizations) and a chain growth polymerization (epoxy homopolymerization). As described herein, in some embodiments, the first stage is a photoinitiated thiol-ene click reaction that rapidly forms a soft, percolated network during printing. In the second stage, applied heat continues to build a soft network based on the addition of thiol-epoxy crosslinks. During a subsequent higher temperature stage, a thermal-latent base creates a stiff, highly crosslinked network based on the anionic homopolymerization of the rigid diepoxy species. The structure-property relationship in the polymers resin mixtures and/or the resulting crosslinked and/or polymerized resulting materials is described herein.

Without wishing to be bound by any particular theory, the stoichiometry described herein and sequencing of these reactions enables control over each stage of curing. In some embodiments, the photoexposure dosage (Hₑ) applied during printing dictates the % conversion (X) of vinyl and thiol groups. In the second stage, the remaining fraction (1−X) of thiols act as a limiting reagent and add mono-functionally to epoxy groups. Lastly, during the third stage, any residual epoxies behave di-functionally and participate in chain-growth homopolymerization. Thus, without wishing to be bound by any particular theory, the photoexposure not only imparts the geometric shape of the printed object but ultimately dictates the local mechanical properties. Without wishing to be bound by any particular theory, at long photo-exposures (X˜1), the material is stiff as the more densely crosslinked, glassy epoxy network dominates. At short photo-exposures (X˜0) the large degree of chain extending thiol-epoxy reactions yields a loosely crosslinked, soft polymer. In either case, by the end of the final stage, the process consumes nearly all thiol and epoxy groups to restrict further reaction.

### Rheological Behavior and FTIR

The rheological behavior and polymerization kinetics of the resin during processing are quantified using photo-/thermal-rheometry and Real-Time Fourier Transform Infrared (FT-IR) spectroscopy. Time-dependent storage modulus (G′) and loss modulus (G″) are evaluated for the first stage thiol-ene photopolymerization with varied degree of photoexposure at room temperature and followed by sequential the thiol-epoxy addition at a first raised temperature and the epoxy homopolymerization at a second raised temperature.

### Mechanical Characterizations

The mechanical properties resulting from printing with varied initial photodosages are also characterized. Tensile test specimens are printed from a commercialized Ember DLP printer using various layer curing times. The resultant polymer is cured at a first raised temperature and followed by postcuring at a second raised temperature. Without wishing to be bound by any particular theory, the initial photodosage, and therefore the structure of the polymer network, dominate the outcomes of the stress-strain behavior.

In some embodiments, the disclosure provides a method of generating a modulus gradient in a polymeric material, the method comprising subjecting an initial precursor resin mixture to a polymerization or crosslinking stimulus, wherein the initial precursor resin mixture comprises one or more monomers, the one or more monomers comprising at least three different polymerizable or crosslinkable moieties, and a silicone backbone. In some embodiments, the method further comprises generating one or more intermediate resin mixtures, wherein the processing further comprises subjecting the one or more intermediate resin mixtures to one or more polymerization and/or crosslinking stimuli. In some embodiments, the one or more intermediate resin mixtures are partially crosslinked or partially polymerized.

In some embodiments, the initial precursor resin mixture comprises one or more monomers, the one or more monomers comprising a first polymerizable and/or crosslinkable moiety, a second polymerizable and/or crosslinkable moiety, and a third polymerizable and/or crosslinkable moiety, and a silicone backbone.

In some embodiments, X is about 0.01, about 0.02, about 0.03, about 0.04, about 0.05, about 0.06, about 0.07, about 0.08, about 0.09, about 0.10, about 0.11, about 0.12, about 0.13, about 0.14, about 0.15, about 0.16, about 0.17, about 0.18, about 0.19, about 0.20, about 0.21, about 0.22, about 0.23, about 0.24, about 0.25, about 0.26, about 0.27, about 0.28, about 0.29, about 0.30, about 0.31, about 0.32, about 0.33, about 0.34, about 0.35, about 0.36, about 0.37, about 0.38, about 0.39, about 0.40, about 0.41, about 0.42, about 0.43, about 0.44, about 0.45, about 0.46, about 0.47, about 0.48, about 0.49, about 0.50, about 0.51, about 0.52, about 0.53, about 0.54, about 0.55, about 0.56, about 0.57, about 0.58, about 0.59, about 0.60, about 0.61, about 0.62, about 0.63, about 0.64, about 0.65, about 0.66, about 0.67, about 0.68, about 0.69, about 0.70, about 0.71, about 0.72, about 0.73, about 0.74, about 0.75, about 0.76, about 0.77, about 0.78, about 0.79, about 0.80, about 0.81, about 0.82, about 0.83, about 0.84, about 0.85, about 0.86, about 0.87, about 0.88, about 0.89, about 0.90, about 0.91, about 0.92, about 0.93, about 0.94, about 0.95, about 0.96, about 0.97, about 0.98, about 0.99, or about 1.

In some embodiments, Y is about 1, about 1.01, about 1.02, about 1.03, about 1.04, about 1.05, about 1.06, about 1.07, about 1.08, about 1.09, about 1.10, about 1.11, about 1.12, about 1.13, about 1.14, about 1.15, about 1.16, about 1.17, about 1.18, about 1.19, about 1.20, about 1.21, about 1.22, about 1.23, about 1.24, about 1.25, about 1.26, about 1.27, about 1.28, about 1.29, about 1.30, about 1.31, about 1.32, about 1.33, about 1.34, about 1.35, about 1.36, about 1.37, about 1.38, about 1.39, about 1.40, about 1.41, about 1.42, about 1.43, about 1.44, about 1.45, about 1.46, about 1.47, about 1.48, about 1.49, about 1.50, about 1.51, about 1.52, about 1.53, about 1.54, about 1.55, about 1.56, about 1.57, about 1.58, about 1.59, about 1.60, about 1.61, about 1.62, about 1.63, about 1.64, about 1.65, about 1.66, about 1.67, about 1.68, about 1.69, about 1.70, about 1.71, about 1.72, about 1.73, about 1.74, about 1.75, about 1.76, about 1.77, about 1.78, about 1.79, about 1.80, about 1.81, about 1.82, about 1.83, about 1.84, about 1.85, about 1.86, about 1.87, about 1.88, about 1.89, about 1.90, about 1.91, about 1.92, about 1.93, about 1.94, about 1.95, about 1.96, about 1.97, about 1.98, about 1.99, or about 2.

In some embodiments, the first polymerizable and/or crosslinkable moiety is an alkene moiety, e.g., and without limitation, vinyl, allyl, acrylate, methacrylate, or the like.

In some embodiments, the first polymerizable and/or crosslinkable moiety is vinyl. In some embodiments, the second polymerizable and/or crosslinkable moiety is a nucleophilic group, e.g., and without limitation, thiol. In some embodiments, the second polymerizable and/or crosslinkable moiety is thiol. In some embodiments, the third polymerizable and/or crosslinkable moiety is a strained three membered ring heterocycle, e.g., and without limitation, epoxy or thiirane. In some embodiments, the third polymerizable and/or crosslinkable moiety is epoxy.

In one embodiment, a polymerizable or crosslinkable moiety is an alkene group. In one embodiment, a polymerizable or crosslinkable moiety is a terminal alkene group. In one embodiment, a polymerizable or crosslinkable moiety is a thiol group. In one embodiment, a polymerizable or crosslinkable moiety is an epoxy group.

In some embodiments, the one or more intermediate resin mixtures comprise at least one group selected from —S— and —S—CH₂—CH(OH)—. In some embodiments, the one or more intermediate resin mixtures comprise at least one group selected from —S—, —S—CH₂—CH(OH)—, and —CH₂—CH(−)—O—. In some embodiments, the polymeric material comprises at least one group selected from —S—, —S—CH₂—CH(OH)—, and —CH₂—CH(−)—O—. In some embodiments, the polymeric material comprises the groups —S—, —S—CH₂—CH(OH)—, and —CH₂—CH(−)—O—.

In some embodiments, the one or more monomers include one or more terminal groups selected from hydrogen, optionally substituted alkyl, optionally substituted heteroalkyl, optionally substituted alkenyl, optionally substituted alkynyl, optionally substituted cycloalkyl, optionally substituted heterocycloalkyl, optionally substituted aryl, optionally substituted arylalkyl, optionally substituted heteroaryl, optionally substituted heteroarylalkyl, optionally substituted acrylate, optionally substituted methacrylate, optionally substituted styrene, optionally substituted epoxide, optionally substituted thiirane, optionally substituted glycidyl, optionally substituted lactone, optionally substituted carbonate, hydroxy, halo, cyano, trifluoromethyl, trifluoromethoxy, nitro, and trimethylsilanyl. In some embodiments, the one or more terminal groups are selected from alkenyl, cycloalkenyl, optionally substituted aryl, and optionally substituted heteroaryl. In some embodiments, the one or more terminal groups are selected from optionally substituted acrylate, optionally substituted methacrylate, optionally substituted vinyl, optionally substituted epoxide, optionally substituted thiirane, optionally substituted glycidyl, and optionally substituted allyl. In some embodiments, the one or more terminal groups are selected from vinyl, allyl, thiol, alcohol, epoxide, thiirane, glycidyl, acrylate, and methacrylate. In some embodiments, the one or more terminal groups are selected from optionally substituted thiophenyl, optionally substituted thiopyranyl, optionally substituted thienothiophenyl, and optionally substituted benzothiophenyl. In some embodiments, the one or more terminal groups are selected from vinyl, thiol, and epoxide (i.e., epoxy).

In some embodiments, the one or more monomers include one or more compounds comprising a polymerizable or crosslinkable group selected from optionally substituted alkenyl, optionally substituted cycloalkenyl, optionally substituted alkynyl, optionally substituted acrylate, optionally substituted methacrylate, optionally substituted styrene, optionally substituted epoxide, optionally substituted thiirane, optionally substituted glycidyl, optionally substituted lactone, optionally substituted lactam, and optionally substituted carbonate. In some embodiments, the polymerizable or crosslinkable group is selected from vinyl, allyl, epoxide, thiol, thiirane, glycidyl, acrylate, and methacrylate.

In some embodiments, the initial precursor resin mixture comprises one or more radical photoinitiator selected from 2,2-dimethoxy-1,2-diphenylethan-1-one, bis(2,4,6-trimethylbenzoyl)—phenylphosphineoxide, 1-hydroxycyclohexyl benzophenone, trimethyl-benzoyl-diphenyl-phosphine-oxide, 2-hydroxy-2-methylpropiophenone, but any radical photoinitiator, or combinations of radical initiators, known in the art can be used without limitation.

In some embodiments, the initial precursor resin mixture comprises one or more base catalysts selected from imidazole, dicyandiamide, allyl 1H-imidazole-1-carboxylate, isopropyl 1H-imidazole-1-carboxylate, 1-(3-aminopropyl)imidazole, 1-(diethoxymethyl)imidazole, trimethylsilyl imidazole, Technicure LC-80, LC-100, Technicure® D, D-5, D-10, D-44, but any base catalyst known in the art can be used without limitation.

In some embodiments, the one or more polymerization and/or crosslinking stimuli are selected from subjecting the initial precursor resin mixture and/or any of the intermediate resin mixtures to a light source and/or a raised temperature. In some embodiments, a polymerization and/or crosslinking stimulus is subjecting the initial precursor resin mixture to a light source. In some embodiments, the polymerization and/or crosslinking stimuli include subjecting any of the intermediate resin mixtures to at least a first raised temperature. In some embodiments, the polymerization and/or crosslinking stimuli include subjecting any of the intermediate resin mixtures to at least a first raised temperature and a second raised temperature. In some embodiments, the polymerization and/or crosslinking stimuli are selected from subjecting any of the intermediate resin mixtures to at least two different raised temperatures.

In some embodiments, a first raised temperature is between about 50° C. and about 150° C. In some embodiments, a first raised temperature is between about 50° C. and about 100° C. In some embodiments, a first raised temperature is between about 75° C. and about 85° C. In some embodiments, a first raised temperature is about 50° C. In some embodiments, a first raised temperature is about 55° C. In some embodiments, a first raised temperature is about 60° C. In some embodiments, a first raised temperature is about 65° C. In some embodiments, a first raised temperature is about 70° C. In some embodiments, a first raised temperature is about 75° C. In some embodiments, a first raised temperature is about 80° C. In some embodiments, a first raised temperature is about 85° C. In some embodiments, a first raised temperature is about 90° C. In some embodiments, a first raised temperature is about 95° C. In some embodiments, a first raised temperature is about 100° C. In some embodiments, a first raised temperature is between about 100° C. and about 150° C. In some embodiments, a first raised temperature is about 80° C., about 90° C., about 100° C., about 110° C., about 120° C., about 130° C., about 140° C., or about 150° C.

In some embodiments, a second raised temperature is between about 100° C. and about 150° C. In some embodiments, a second raised temperature is between about 115° C. and about 125° C. In some embodiments, a second raised temperature is about 100° C. In some embodiments, a second raised temperature is about 105° C. In some embodiments, a second raised temperature is about 110° C. In some embodiments, a second raised temperature is about 115° C. In some embodiments, a second raised temperature is about 120° C. In some embodiments, a second raised temperature is about 125° C. In some embodiments, a second raised temperature is about 130° C. In some embodiments, a second raised temperature is about 135° C. In some embodiments, a second raised temperature is about 140° C. In some embodiments, a second raised temperature is about 145° C. In some embodiments, a second raised temperature is about 150° C. In some embodiments, a second raised temperature is about 155° C. In some embodiments, a second raised temperature is about 160° C. In some embodiments, a second raised temperature is about 165° C. In some embodiments, a second raised temperature is about 170° C. In some embodiments, a second raised temperature is about 175° C.

In some embodiments, a ramp rate to the first raised temperature or to the second raised temperature is between about 0.5° C./min and about 10° C./min. In some embodiments, a ramp rate to the first raised temperature or to the second raised temperature is between about 0.5° C./min and about 20° C./min. In some embodiments, a ramp rate to the first raised temperature or to the second raised temperature is about 0.5° C./min, about 1° C./min, about 2° C./min, about 5° C./min, about 10° C./min, or about 20° C./min. In some embodiments, a ramp rate to the first raised temperature or to the second raised temperature is about 0.5° C./min. In some embodiments, a ramp rate to the first raised temperature or to the second raised temperature is about 1° C./min. In some embodiments, a ramp rate to the first raised temperature or to the second raised temperature is about 1.5° C./min. In some embodiments, a ramp rate to the first raised temperature or to the second raised temperature is about 2° C./min. In some embodiments, a ramp rate to the first raised temperature or to the second raised temperature is about 2.5° C./min. In some embodiments, a ramp rate to the first raised temperature or to the second raised temperature is about 3° C./min. In some embodiments, a ramp rate to the first raised temperature or to the second raised temperature is about 3.5° C./min. In some embodiments, a ramp rate to the first raised temperature or to the second raised temperature is about 4° C./min. In some embodiments, a ramp rate to the first raised temperature or to the second raised temperature is about 4.5° C./min. In some embodiments, a ramp rate to the first raised temperature or to the second raised temperature is about 5° C./min. In some embodiments, a ramp rate to the first raised temperature or to the second raised temperature is about 6° C./min. In some embodiments, a ramp rate to the first raised temperature or to the second raised temperature is about 7° C./min. In some embodiments, a ramp rate to the first raised temperature or to the second raised temperature is about 8° C./min. In some embodiments, a ramp rate to the first raised temperature or to the second raised temperature is about 9° C./min. In some embodiments, a ramp rate to the first raised temperature or to the second raised temperature is about 10° C./min.

In some embodiments, the initial precursor resin mixture further comprises a photoinitiator. In some embodiments, the modulus is selected from Young's modulus (E), shear modulus or modulus of rigidity (G), and bulk modulus (K). In some embodiments, the modulus is Young's modulus (E). In some embodiments, the modulus is storage modulus and/or loss modulus. In some embodiments, the method is a 3D printing method.

In some embodiments, the initial precursor resin mixture further comprises a photoinitiator. The photoinitiator chemically initiates the polymerization of a photoactive polymerizable material. The photoinitiator generally should offer a source of species that initiate polymerization of the particular photoactive polymerizable material, e.g., photoactive monomer. Typically, from about 0.1 to about 20 vol. % photoinitiator provides desirable results. A variety of photoinitiators known to those skilled in the art and available commercially are suitable for use as described herein, for example, those comprising a phosphine oxide group, such as diphenyl(2,4,6-trimethylbenzoyl)phosphine oxide, disclosed in U.S. Pat. No. 6,780,546 (Trentler et al.), issued Aug. 24, 2004, incorporated herein by reference. In some embodiments, the photoinitiator is sensitive to light at wavelengths available from conventional laser sources, e.g., the blue and green lines of Ar⁺ (458, 488, 514 nm) and He—Cd lasers (442 nm), the green line of frequency doubled YAG lasers (532 nm), and the red lines of He—Ne (633 nm), Kr⁺ lasers (647 and 676 nm), and various diode lasers (290 to 900 nm). In some embodiments, the free radical photoinitiator bis(η-5-2,4-cyclopentadien-1-yl)bis[2,6-difluoro-3-(1H-pyrrol-1-yl)phenyl]titanium can be used. In some embodiments, the free radical photoinitiator 2,2-dimethoxy-1,2-diphenylethan-1-one can be used. In some embodiments, the free radical photoinitiator bis(2,4,6-trimethylbenzoyl)—phenylphosphineoxide can be used. In some embodiments, the free radical photoinitiator 1-hydroxycyclohexyl benzophenone can be used. In some embodiments, the free radical photoinitiator trimethyl-benzoyl-diphenyl-phosphine-oxide can be used. In some embodiments, the free radical photoinitiator 2-hydroxy-2-methylpropiophenone can be used.

In some embodiments, the free-radical photoinitiator 5,7-diiodo-3-butoxy-6-fluorone can be used. In some embodiments, this photoinitiator requires a co-initiator. Free-radical photoinitiators of dye-hydrogen donor systems can also be used. Examples of suitable dyes include eosin, rose bengal, erythrosine, and methylene blue, and suitable hydrogen donors include tertiary amines such as n-methyl diethanol amine. In the case of cationically polymerizable components, a cationic photoinitiator is used, such as a sulfonium salt or an iodonium salt. These cationic photoinitiator salts absorb predominantly in the UV portion of the spectrum, and are therefore typically sensitized with a sensitizer or dye to allow use of the visible portion of the spectrum. An example of an alternative visible cationic photoinitiator is (η₅-2,4-cyclopentadien-1-yl) (η₆-isopropylbenzene)—iron(II) hexafluorophosphate. In some embodiments, photoinitiators used herein are sensitive to ultraviolet and visible radiation of from about 200 nm to about 800 nm. In some embodiments, other additives can be used in the photoimageable system, e.g., inert diffusing agents having relatively high or low refractive indices.

In some embodiments, a polymer article described herein may also include additives such as plasticizers for altering the properties of the article of the present disclosure including the melting point, flexibility, toughness, diffusibility of the monomers and/or oligomers, and ease of processability. Examples of suitable plasticizers include dibutyl phthalate, poly(ethylene oxide) methyl ether, N,N-dimethylformamide, etc. Plasticizers differ from solvents in that solvents are typically evaporated whereas plasticizers are meant to remain in the article.

Other types of additives that may be used in a resin mixture and article of the present disclosure are inert diffusing agents having relatively high or low refractive indices. Other additives that may be used in a resin mixture and article of the present disclosure include: pigments, fillers, nonphotoinitiating dyes, antioxidants, bleaching agents, mold releasing agents, antifoaming agents, infrared/microwave absorbers, surfactants, adhesion promoters, etc.

Suitable polymerization retarders and inhibitors for use herein include but are not limited to one or more of the following: for free radical polymerizations, various phenols including butylated hydroxytoluenes (BHT) such as 2,6-di-t-butyl-p-cresol, p-methoxyphenol, diphenyl-p-benzoquinone, benzoquinone, hydroquinone, pyrogallol, resorcinol, phenanthraquinone, 2,5-toluquinone, benzylaminophenol, p-dihydroxybenzene, 2,4,6-trimethylphenol, etc.; various nitrobenzenes including o-dinitrobenzene, p-dinitrobenzene, m-dinitrobenzene, etc.; N-phenyl-1-naphthylamine, N-phenyl-2-naphthylamine, cupferron, phenothiazine, tannic acid, p-nitrosamine, chloranil, aniline, hindered anilines, ferric chloride, cupric chloride, triethylamine, etc. These polymerization retarders and inhibitors can be used individually (e.g., a single retarder) or in combinations of two or more, e.g., a plurality of retarders. The same principles can be applied to ionic polymerizations. For example, it is known that chloride anions can behave as retarders or inhibitors for cationic polymerizations, depending on both the monomer type and the concentration of the chloride anions. Typically, functionalities that are basic or mildly nucleophilic behave as retarders and inhibitors for cationic polymerizations; whereas for anionic polymerizations, slightly acidic and mildly electrophilic functionalities behave as retarders and inhibitors.

In some embodiments, polymerization reactions involving both polymerization retarders and inhibitors should lead to termination reactions. If reinitiation occurs to any appreciable degree, then the agent is typically considered a chain transfer agent. For example, triethylamine can be used as a chain transfer agent since it is also capable of reinitiating some radical polymerizations; however, when the reinitiation is slow compared to termination reactions, then even chain transfer agents can be considered potential polymerization retarders or inhibitors for the purposes of the present disclosure. Suitable chain transfer agents for use herein include but are not limited to: triethylamine, thioethers, compounds having carbonate groups, ethers, toluene derivatives, allyl ethers, etc. Chain transfer agents that are mildly retarding can be desirable because these can be incorporated into the matrix and enable attachment of the photopolymer and photoinitiator radicals to the matrix.

In addition to retarders, inhibitors and/or chain transfer agents, metastable reactive centers and light labile phototerminators can also be used to control polymerization reactions described herein of the appropriate reactivity. For example, nitroxyl radicals can be added as a metastable reactive center. Nitroxyl radicals create pseudo-living radical polymerizations with certain monomers. Thus, the nitroxyl radical initially behaves as a terminating agent (such as an inhibitor), however, depending on the temperature at which the polymerization is carried out, the termination is reversible. Other potential metastable reactive center include triphenylmethyl radicals, dithioesters are typically used in Reversible Addition-Fragmentation chain Transfer (RAFT) polymerizations, that can behave as appropriate metastable reactive centers, etc. As for ionic polymerizations, there are stable ions that are able to perform the same function, as the example nitroxyl radicals above.

Use of a light labile phototerminator provides the ability to control the activity of the reactive species with light (as opposed to heat as described herein). A light labile phototerminator is any molecule capable of undergoing reversible termination reactions using a light source. For example, certain cobaltoxime complexes can be used to photoinitiate radical polymerizations, and yet, also terminate the same radical polymerizations. Dithioesters are also suitable as light labile phototerminators because they have the ability to reversibly form radicals with appropriate wavelengths of light. Under the appropriate conditions and with appropriate monomers (such as styrenes and acrylates), it is possible to restart the polymerization by irradiating with a photoinitiating light source (e.g., recording light). Thus, as long as a given volume is exposed to a photoinitiating light source, radical polymerization continues, whereas when the photoinitiating light is off or absent, the polymerizations are terminated. Metastable reactive centers and light labile phototerminators can also be used to control ionic (e.g., cationic or anionic initiated) polymerization reaction systems according to the present disclosure.

For ionic chain reactions (e.g., cationic and anionic initiated polymerization reactions), counter ion and solvent effects can be used to control polymerization by terminating the reactive center. Ionic systems are sensitive to solvent conditions because the solvent (or the support matrix) determines the proximity of the counter ion to the reactive center. For instance, in a nonpolar medium the counter ion will be very closely associated with the reactive center; in a polar medium the counter ion may become freely dissociated. The proximity of the counter ion can determine polymerization rate as well as the potential for collapse with the counter ion (depending on the counter ion used). For example, if one uses a cationic polymerization with a nonpolar support matrix and chloride anion as the counter ion, there is a better probability of terminating the reaction due to collapse of the counter ion.

Certain monomer mixtures can also behave in a manner that can control the degree or rate of polymerization. For example, if a small amount of alpha methyl styrene is present in an acrylate polymerization, the acrylate will add into the alpha methyl styrene and the styrene will not substantially reinitiate polymerization of the acrylate, e.g., the alpha methyl styrene retards the rate of acrylate polymerization. Additionally, the alpha methyl styrene is slow to polymerize with itself, and thus behaves as a polymerization retarder/inhibitor even though it is a comonomer. In the case of ionic polymerizations; using, for example, vinyl anisole in a cationic vinyl ether polymerization results in retarded rates of polymerization because the vinyl anisole does not efficiently reinitiate vinyl ether polymerization.

The disclosure also provides a polymeric material having at least one modulus gradient in a spatial direction, the polymeric material made by a method described herein.

The disclosure also provides a polymeric material having a modulus gradient over one spatial direction, wherein modulus is measured in a plurality of voxels. Voxel refers to a volumetric pixel, or the smallest unit of discrete 3D space that can be selectively illuminated, e.g., selectively illuminated by a light source such as a 3D printer light source. Without wishing to be bound by any particular theory, in some embodiments, a voxel is about 800 nm in each dimension (2×405 nm excitation due to diffraction limit).

In some embodiments, the modulus is selected from Young's modulus (E), shear modulus or modulus of rigidity (G), and bulk modulus (K). In some embodiments, the modulus is Young's modulus (E). In some embodiments, the modulus is storage modulus and/or loss modulus. In some embodiments, the modulus ranges from about 10²to about 10¹⁰ Pa. In some embodiments, the modulus ranges from about 10² to about 10¹⁰ Pa. In some embodiments, the modulus ranges from about 10³ to about 10⁷ Pa. In some embodiments, the modulus ranges from about 10⁵ to about 10¹⁰ Pa. In some embodiments, the modulus ranges from about 10³ to about 10⁵ Pa. In some embodiments, the modulus ranges from about 10⁵ to about 10⁸ Pa. In some embodiments, the polymeric material comprises at least one group selected from —S—, —S—CH₂—CH(OH)—, and —CH₂—CH(−)—O—. In some embodiments, the modulus gradient is between values having the same degree of magnitude. In some embodiments, the modulus gradient is between values one degree of magnitude apart. In some embodiments, the modulus gradient is between values two degrees of magnitude apart. In some embodiments, the modulus gradient is between values three degrees of magnitude apart. In some embodiments, the modulus gradient is between values four degrees of magnitude apart.

In some embodiments, the modulus gradient is between values five degrees of magnitude apart. In some embodiments, the modulus gradient is between values six degrees of magnitude apart. Modulus can be measured by atomic force microscopy (AFM) with sub 10 nm resolution in any dimension.

In some embodiments, the polymeric material (e.g., silicone material) described herein is incorporated into a device. Exemplary devices include, but are not limited to, a head-wearable device (e.g., a virtual-reality headset, smart glasses, augmented-reality glasses), a wrist-wearable device (e.g., a smartwatch), a smart textile-based garment, a haptic feedback device (e.g., a haptic display), a biomedical device, and/or other consumer devices.

The following clauses describe certain embodiments.

Clause 1: A silicone material having a modulus gradient over one spatial direction, wherein modulus is measured in a plurality of voxels, the material comprising a partially or fully polymerized or crosslinked silicone resin.

Clause 2. The silicone material of clause 1, wherein the modulus is selected from Young's modulus (E), shear modulus or modulus of rigidity (G), and bulk modulus (K).

Clause 3. The silicone material of clause 1, wherein the modulus is Young's modulus (E).

Clause 4. The silicone material of clause 1, wherein the modulus is storage modulus and/or loss modulus.

Clause 5. The silicone material of any one of clauses 1 to 4, wherein the modulus ranges from about 10² to about 10¹⁰ Pa.

Clause 6a. The silicone material of any one of clauses 1 to 4, wherein the modulus ranges from about 10³to about 10⁵ Pa. Clause 6b. The silicone material of any one of clauses 1 to 4, wherein the modulus ranges from about 10³ to about 10⁷ Pa. Clause 6c. The silicone material of any one of clauses 1 to 4, wherein the modulus ranges from about 10⁵ to about 10⁶ Pa. Clause 6d. The silicone material of any one of clauses 1 to 4, wherein the modulus ranges from about 10⁶ to about 10⁷ Pa.

Clause 7. The silicone material of any one of clauses 1 to 4, wherein the modulus ranges from about 10⁵ to about 10¹⁰ Pa.

Clause 8. The silicone material of any one of clauses 1 to 7, wherein the silicone material comprises a polymer backbone comprising a group selected from —Si(CH₃)₂—, —O—Si(CH₃)₂—, and —O—(CH₂)ₙ—, wherein n is integer from 1 to 3, from 4 to 6, or from 7 to 12.

Clause 9. The silicone material of any one of clauses 1 to 7, wherein the silicone resin comprises a polymer backbone comprising a group selected from —Si(CH₃)2—, —O—Si(CH₃)₂—, and —O—(CH₂)ₙ—, wherein n is integer from 1 to 3, from 4 to 6, or from 7 to 12.

Clause 10. The silicone material of any one of clauses 1 to 9, wherein the silicone resin prior to polymerization and/or crosslinking comprises three different polymerizable or crosslinkable moieties.

Clause 11. The silicone material of clause 10, wherein the stoichiometric ratio of three different polymerizable or crosslinkable moieties is 1:X:Y, wherein X<1, and X+Y≥1.

Clause 12. The silicone material of clause 10, wherein the three different polymerizable or crosslinkable moieties are an alkene group, a thiol group, and an epoxy group.

Clause 13. The silicone material of clause 12, wherein the stoichiometric ratio of thiol groups to alkene groups to epoxy groups is 1:X:Y, wherein X<1, and X+Y≥1.

Clause 14a. The silicone material of any one of clauses 11 to 13, wherein (1-X)≤Y≤2. Clause 14b. The silicone material of any one of clauses 11-14a, wherein 1≤Y≤2. The silicone material of any one of clauses 11 to 14a, wherein Y≤1.

Clause 15. The silicone material of any one of clauses 1 to 14, wherein the silicone resin comprises a multifunctional vinyl or ene silicone, a multifunctional epoxide silicone, and a multifunctional thiol silicone.

Clause 16. The silicone material of clause 15, wherein the multifunctional vinyl or ene silicone has a functionality between about 4 and about 500.

Clause 17. The silicone material of clause 15 or 16, wherein the multifunctional epoxide silicone has a functionality between about 1.9 and about 4.

Clause 18. The silicone material of any one of clauses 15 to 17, wherein the multifunctional thiol silicone has a functionality between about 1.9 and about 4.

Clause 19. The silicone material of any one of clauses 1 to 14, wherein the silicone resin comprises a multifunctional vinyl or ene silicone, a diepoxide silicone, and a dithiol silicone.

Clause 20. The silicone material of any one of clauses 15 to 19, wherein the multifunctional vinyl silicone is selected from VDT-5035, VDT-954, VDT-731, VDT-431, and VMS-T11.

Clause 21. The silicone material of any one of clauses 15 to 20, wherein the diepoxide silicone is selected from DMS-E09, DMS-E11, DMS-E12, DMS-E21, EP-J10, and combinations thereof.

Clause 22. The silicone material of any one of clauses 15 to 21, wherein the dithiol silicone is selected from X-22-167C, X-22-167B, SMS-042, mercaptopropyl terminated polydimethylsiloxane, and 3-[(dimethyl-3-(sulfanylpropyl)silyl)oxy-dimethylsilyl]propane-1-thiol.

Clause 23. The silicone material of any one of clauses 1 to 22, wherein the silicone material comprises at least one group selected from —S—, —S—CH₂—CH₂—, —S—CH₂—CH(OH)—, —CH₂—CH(−)—O—, and —CH₂—CH(−)—O—CH₂—CH(OH)—.

Clause 24. The silicone material of any one of clauses 1 to 23, wherein the silicone material comprises a thiol-vinyl or thiol-ene adduct moiety, a thiol-epoxy adduct moiety, an alcohol-epoxy adduct moiety, and/or an epoxy-epoxy adduct moiety.

Clause 25. The silicone material of clause 24, wherein the stoichiometric ratio of thiol-vinyl or thiol-ene adduct moieties to thiol-epoxy adduct moieties is X:(1−X), wherein X<1.

Clause 26. The silicone material of clause 24, wherein the stoichiometric ratio of thiol-vinyl adduct moieties or thiol-ene adduct moieties to thiol-epoxy adduct moieties to alcohol-epoxy adduct moieties and/or epoxy-epoxy adduct moieties is X:(1−X):(Y−(1−X)), wherein X<1, and X+Y≥1.

Clause 27a. The silicone material of clause 26, wherein (1−X)≤Y≤2. Clause 27b. The silicone material of clause 26, wherein 1≤Y≤2. Clause 27c. The silicone material of clause 26, wherein Y≤1.

Clause 28. The silicone material of any one of clauses 1 to 27, wherein the silicone resin further comprises a photoinitiator and/or a thermal initiator.

Clause 29. The silicone material of any one of clauses 1 to 28, wherein the silicone material is 3D printed.

Clause 30. A method of generating a modulus gradient in a silicone material, the method comprising: subjecting an initial precursor silicone resin mixture to a first polymerization and/or crosslinking stimulus, wherein the initial precursor silicone resin mixture comprises a plurality of monomers, polymers, or oligomers comprising at least three different polymerizable or crosslinkable moieties, wherein the at least three different polymerizable or crosslinkable moieties are selected from an alkene group, a thiol group, and an epoxy group, generating an intermediate silicone resin mixture, and subjecting the intermediate silicone resin mixture to a second polymerization and/or crosslinking stimulus.

Clause 31. The method of clause 30, wherein the stoichiometric ratio of thiol groups to alkene groups to epoxy groups in the initial precursor silicone resin mixture is 1:X:Y, wherein X<1, and X+Y≥1.

Clause 32a. The method of clause 31, wherein (1−X)≤Y≤2. Clause 32b. The silicone material of clause 31, wherein 1≤Y≤2. Clause 32c. The silicone material of claim 31, wherein Y≤1.

Clause 33. The method of any one of clauses 30 to 32, wherein the intermediate silicone resin mixture is partially crosslinked or polymerized.

Clause 34. The method of any one of clauses 30 to 33, wherein the intermediate silicone resin mixture comprises at least one group selected from —S—, —CH₂—CH₂—, and —S—CH₂—CH₂—.

Clause 35. The method of any one of clauses 30 to 33, wherein the silicone material comprises at least one group selected from —S—, —S—CH₂—CH₂—, —S—CH₂—CH(OH)—, —CH₂—CH(−)—O—, and —CH₂—CH(−)—O—CH₂—CH(OH)—.

Clause 36. The method of any one of clauses 30 to 33, wherein the silicone material comprises a thiol-vinyl or thiol-ene adduct moiety, a thiol-epoxy adduct moiety, and an alcohol-epoxy or epoxy-epoxy adduct moiety.

Clause 37. The method of any one of clauses 30 to 36, wherein the stoichiometric ratio of thiol-vinyl or thiol-ene adduct moieties to thiol-epoxy adduct moieties is X:(1−X), wherein X<1.

Clause 38. The method of any one of clauses 30 to 36, wherein the stoichiometric ratio of thiol-vinyl adduct moieties or thiol-ene adduct moieties to thiol-epoxy adduct moieties to alcohol-epoxy adduct moieties and/or epoxy-epoxy adduct moieties is X:(1−X):(Y−(1−X)), wherein X<1, and X+Y≥1.

Clause 39a. The method of clause 38, wherein (1−X)≤Y≤2. Clause 39b. The method of clause 39a, wherein 1≤Y≤2. Clause 39c. The method of clause 39a, wherein Y≤1.

Clause 40a. The method of any one of clauses 30 to 39, wherein the monomer, polymer, and/or oligomer is selected from a monofunctional monomer, polymer, and/or oligomer, a bifunctional monomer, polymer, and/or oligomer, a trifunctional monomer, polymer, and/or oligomer, and a tetrafunctional monomer, polymer, and/or oligomer. Clause 40b. The method of any one of clauses 30 to 39, wherein the monomer, polymer, and/or oligomer has a Tg<−50° C.

Clause 41. The method of any one of clauses 30 to 39, wherein the monomer, polymer, and/or oligomer are selected from a multifunctional vinyl silicone, a diepoxide silicone, and a dithiol silicone.

Clause 42. The method of clause 41, wherein the multifunctional vinyl silicone is selected from VDT-5035, VDT-954, VDT-731, VDT-431, and VMS-T11.

Clause 43. The method of clause 41 or 42, wherein the diepoxide silicone is selected from DMS-E09, DMS-E11, DMS-E12, DMS-E21, EP-J10, and combinations thereof.

Clause 44. The method of any one of clauses 41 to 43, wherein the dithiol silicone is selected from X-22-167C, X-22-167B, SMS-042, mercaptopropyl terminated polydimethylsiloxane, and 3-[(dimethyl-3-(sulfanylpropyl)silyl)oxy-dimethylsilyl]propane-1-thiol.

Clause 45. The method of any one of clauses 30 to 44, wherein the first and/or second polymerization and/or crosslinking stimulus is selected from subjecting the initial precursor silicone resin mixture and/or any of the intermediate silicone resin mixtures to a light source and/or a raised temperature.

Clause 46. The method of any one of clauses 30 to 44, wherein the first polymerization and/or crosslinking stimulus is subjecting the initial precursor silicone resin mixture to a light source.

Clause 47. The method of any one of clauses 30 to 46, wherein the second polymerization and/or crosslinking stimulus is selected from subjecting any of the intermediate silicone resin mixtures to a first raised temperature above room temperature.

Clause 48. The method of any one of clauses 30 to 47, further comprising subjecting any of the intermediate silicone resin mixtures to a second raised temperature above room temperature.

Clause 49. The method of clause 47, wherein a first raised temperature above room temperature is between about 75° C. and about 150° C.

Clause 50. The method of clause 47, wherein a first raised temperature above room temperature is between about 90° C. and about 120° C.

Clause 51. The method of clause 48, wherein a second raised temperature above room temperature is between about 125° C. and about 200° C.

Clause 52. The method of clause 48, wherein a second raised temperature above room temperature is between about 150° C. and about 170° C.

Clause 53. The method of any one of clauses 30 to 52, wherein the initial precursor silicone resin mixture further comprises a photoinitiator and/or a thermal initiator.

Clause 54. The method of any one of clauses 30 to 53, wherein the modulus is selected from Young's modulus (E), shear modulus or modulus of rigidity (G), and bulk modulus (K).

Clause 55. The method of any one of clauses 30 to 53, wherein the modulus is storage modulus and/or loss modulus.

Clause 56. The method of any one of clauses 30 to 55, wherein a first portion of the precursor resin is exposed to the first polymerization and/or crosslinking stimulus, and a second portion of the precursor resin is shielded from the first polymerization and/or crosslinking stimulus.

Clause 57. The method of any one of clauses 30 to 55, wherein a first portion of the precursor resin is exposed to a first dosage of the first polymerization and/or crosslinking stimulus, and a second portion of the precursor resin is exposed to a second dosage of the first polymerization and/or crosslinking stimulus, wherein the first dosage and the second dosage are different.

Clause 58. The method of any one of clauses 30 to 57, wherein the method is a 3D printing method.

Clause 59. A silicone material having at least one modulus gradient in a spatial direction, the silicone material made by a method of any one of clauses 30 to 56.

Clause 60. In some embodiments, according to any one of the previous clauses, a siloxane monomer, polymer, and/or oligomer of the invention has a Tg<−50° C.

Clause 101. A silicone material having a modulus gradient over one spatial direction, wherein modulus is measured in a plurality of voxels, the material comprising a partially or fully polymerized or crosslinked silicone resin.

Clause 102. The silicone material of clause 101, wherein the modulus is selected from Young's modulus (E), shear modulus or modulus of rigidity (G), and bulk modulus (K).

Clause 103. The silicone material of clause 101, wherein the modulus is Young's modulus (E).

Clause 104. The silicone material of clause 101, wherein the modulus is storage modulus and/or loss modulus.

Clause 105a. The silicone material of any one of clauses 101 to 104, wherein the modulus ranges from about 10² to about 10¹⁰ Pa. Clause 105b. The silicone material of any one of clauses 101 to 104, wherein the modulus ranges from about 10² to about 10³ Pa, about 10³ to about 10⁴ Pa, about 10⁴ to about 10⁵ Pa, about 10⁵ to about 10⁶ Pa, about 10⁶ to about 10⁷ Pa, about 10⁷ to about 10⁸ Pa, about 10⁸ to about 10⁹ Pa, or about 10⁹ to about 10¹⁰ Pa.

Clause 106. The silicone material of any one of clauses 101 to 104, wherein the modulus ranges from about 10³ to about 10⁷ Pa.

Clause 107. The silicone material of any one of clauses 101 to 104, wherein the modulus ranges from about 10⁵ to about 10¹⁰ Pa.

Clause 108. The silicone material of any one of clauses 101 to 107, wherein the silicone material comprises a polymer backbone comprising a group selected from —Si(CH₃)₂—, —O—Si(CH₃)₂—, and —O—(CH₂)n—, wherein n is integer from 1 to 3, from 4 to 6, or from 7 to 12. In some embodiments, n is integer selected from 1, 2, 3, 4, 5, 6, 7, 8, 9, 10, 11, and 12.

Clause 109. The silicone material of any one of clauses 101 to 107, wherein the silicone resin comprises a polymer backbone comprising a group selected from —Si(CH₃)₂—, —O—Si(CH₃)₂—, and —O—(CH₂)n—, wherein n is integer from 1 to 3, from 4 to 6, or from 7 to 12. In some embodiments, n is integer selected from 1, 2, 3, 4, 5, 6, 7, 8, 9, 10, 11, and 12.

Clause 110. The silicone material of any one of clauses 101 to 109, wherein the silicone resin prior to polymerization and/or crosslinking comprises three different polymerizable or crosslinkable moieties.

Clause 111. The silicone material of clause 110, wherein the stoichiometric ratio of three different polymerizable or crosslinkable moieties is 1:X:Y, wherein X<1, and X+Y≥1.

Clause 112. The silicone material of clause 110, wherein the three different polymerizable or crosslinkable moieties are an alkene group, a thiol group, and an epoxy group.

Clause 113. The silicone material of clause 112, wherein the stoichiometric ratio of thiol groups to alkene groups to epoxy groups is 1:X:Y, wherein X<1, and X+Y≥1.

Clause 114. The silicone material of any one of clauses 111 to 113, wherein (1−X)≤Y≤2.

Clause 115. The silicone material of any one of clauses 111 to 114, wherein 1≤Y≤2.

Clause 116. The silicone material of any one of clauses 111 to 114, wherein Y≤1.

Clause 117. The silicone material of any one of clauses 101 to 116, wherein the silicone resin comprises a multifunctional vinyl or ene silicone, a multifunctional epoxide silicone, and a multifunctional thiol silicone.

Clause 118. The silicone material of clause 117, wherein the multifunctional vinyl or ene silicone has a functionality between about 4 and about 500.

Clause 119. The silicone material of clause 117 or 118, wherein the multifunctional epoxide silicone has a functionality between about 1.9 and about 4.

Clause 120. The silicone material of any one of clauses 117 to 119, wherein the multifunctional thiol silicone has a functionality between about 1.9 and about 4.

Clause 121. The silicone material of any one of clauses 101 to 16, wherein the silicone resin comprises a multifunctional vinyl or ene silicone, a diepoxide silicone, and a dithiol silicone.

Clause 122. The silicone material of any one of clauses 117 to 121, wherein the multifunctional vinyl silicone is selected from VDT-5035, VDT-954, VDT-731, VDT-431, and VMS-T11.

Clause 123. The silicone material of any one of clauses 117 to 122, wherein the diepoxide silicone is selected from DMS-E09, DMS-E11, DMS-E12, DMS-E21, EP-J10, and combinations thereof.

Clause 124. The silicone material of any one of clauses 117 to 123, wherein the dithiol silicone is selected from X-22-167C, X-22-167B, SMS-042, mercaptopropyl terminated polydimethylsiloxane, and 3-[(dimethyl-3-(sulfanylpropyl)silyl)oxy-dimethylsilyl]propane-1-thiol.

Clause 125. The silicone material of any one of clauses 101 to 124, wherein the silicone material comprises at least one group selected from —S—, —S—CH₂—CH₂—, —S—CH₂—CH(OH)—, —CH₂—CH(−)—O—, and —CH₂—CH(−)—O—CH₂—CH(OH)—.

Clause 126. The silicone material of any one of clauses 101 to 125, wherein the silicone material comprises a thiol-vinyl or thiol-ene adduct moiety, a thiol-epoxy adduct moiety, an alcohol-epoxy adduct moiety, and/or an epoxy-epoxy adduct moiety.

Clause 127. The silicone material of clause 126, wherein the stoichiometric ratio of thiol-vinyl or thiol-ene adduct moieties to thiol-epoxy adduct moieties is X:(1−X), wherein X<1.

Clause 128. The silicone material of clause 126, wherein the stoichiometric ratio of thiol-vinyl adduct moieties or thiol-ene adduct moieties to thiol-epoxy adduct moieties to alcohol-epoxy adduct moieties and/or epoxy-epoxy adduct moieties is X:(1−X):(Y−(1−X)), wherein X<1, and X+Y≥1.

Clause 129. The silicone material of clause 128, wherein (1−X)≤Y≤2.

Clause 130. The silicone material of clause 128, wherein 1≤Y≤2.

Clause 131. The silicone material of clause 128, wherein Y≤1.

Clause 132. The silicone material of any one of clauses 101 to 131, wherein the silicone resin further comprises a photoinitiator and/or a thermal initiator.

Clause 133. The silicone material of any one of clauses 101 to 132, wherein the silicone material is 3D printed.

Clause 134. A method of generating a modulus gradient in a silicone material, the method comprising: subjecting an initial precursor silicone resin mixture to a first polymerization and/or crosslinking stimulus, wherein the initial precursor silicone resin mixture comprises a plurality of monomers, polymers, or oligomers comprising at least three different polymerizable or crosslinkable moieties, wherein the at least three different polymerizable or crosslinkable moieties are selected from an alkene group, a thiol group, and an epoxy group; generating an intermediate silicone resin mixture; and subjecting the intermediate silicone resin mixture to a second polymerization and/or crosslinking stimulus.

Clause 135. The method of clause 134, wherein the stoichiometric ratio of thiol groups to alkene groups to epoxy groups in the initial precursor silicone resin mixture is 1:X:Y, wherein X<1, and X+Y≥1.

Clause 136. The method of clause 135, wherein (1−X)≤Y≤2.

Clause 137. The method of clause 136, wherein 1≤Y≤2.

Clause 138. The method of clause 136, wherein Y≤1.

Clause 139. The method of any one of clauses 134 to 138, wherein the intermediate silicone resin mixture is partially crosslinked or polymerized.

Clause 140. The method of any one of clauses 134 to 139, wherein the intermediate silicone resin mixture comprises at least one group selected from —S—, —CH₂—CH₂—, and —S—CH₂—CH₂—.

Clause 141. The method of any one of clauses 134 to 139, wherein the silicone material comprises at least one group selected from —S—, —S—CH₂—CH₂—, —S—CH₂—CH(OH)—, —CH₂—CH(−)—O—, and —CH₂—CH(−)—O—CH₂—CH(OH)—.

Clause 142. The method of any one of clauses 134 to 139, wherein the silicone material comprises a thiol-vinyl or thiol-ene adduct moiety, a thiol-epoxy adduct moiety, and an alcohol-epoxy or epoxy-epoxy adduct moiety.

Clause 143. The method of any one of clauses 134 to 142, wherein the stoichiometric ratio of thiol-vinyl or thiol-ene adduct moieties to thiol-epoxy adduct moieties is X: (1−X), wherein X<1.

Clause 144. The method of any one of clauses 134 to 142, wherein the stoichiometric ratio of thiol-vinyl adduct moieties or thiol-ene adduct moieties to thiol-epoxy adduct moieties to alcohol-epoxy adduct moieties and/or epoxy-epoxy adduct moieties is X:(1−X): (Y-(1−X)), wherein X<1, and X+Y≥1.

Clause 145. The method of clause 144, wherein (1−X)≤Y≤2.

Clause 146. The method of clause 144, wherein 1≤Y≤2.

Clause 147. The method of clause 144, wherein Y≤1.

Clause 148. The method of any one of clauses 134 to 147, wherein the monomer, polymer, and/or oligomer is selected from a monofunctional monomer, polymer, and/or oligomer, a bifunctional monomer, polymer, and/or oligomer, a trifunctional monomer, polymer, and/or oligomer, and a tetrafunctional monomer, polymer, and/or oligomer.

Clause 149. The method of any one of clauses 134 to 147, wherein the monomer, polymer, and/or oligomer are selected from a multifunctional vinyl silicone, a diepoxide silicone, and a dithiol silicone.

Clause 150. The method of clause 149, wherein the multifunctional vinyl silicone is selected from VDT-5035, VDT-954, VDT-731, VDT-431, and VMS-T11.

Clause 151. The method of clause 149 or 150, wherein the diepoxide silicone is selected from DMS-E09, DMS-E11, DMS-E12, DMS-E21, EP-J10, and combinations thereof.

Clause 152. The method of any one of clauses 149 to 151, wherein the dithiol silicone is selected from X-22-167C, X-22-167B, SMS-042, mercaptopropyl terminated polydimethylsiloxane, and 3-[(dimethyl-3-(sulfanylpropyl)silyl)oxy-dimethylsilyl]propane-1-thiol.

Clause 153. The method of any one of clauses 134 to 152, wherein the first and/or second polymerization and/or crosslinking stimulus is selected from subjecting the initial precursor silicone resin mixture and/or any of the intermediate silicone resin mixtures to a light source and/or a raised temperature.

Clause 154. The method of any one of clauses 134 to 152, wherein the first polymerization and/or crosslinking stimulus is subjecting the initial precursor silicone resin mixture to a light source.

Clause 155. The method of any one of clauses 134 to 154, wherein the second polymerization and/or crosslinking stimulus is selected from subjecting any of the intermediate silicone resin mixtures to a first raised temperature above room temperature.

Clause 156. The method of any one of clauses 134 to 155, further comprising subjecting any of the intermediate silicone resin mixtures to a second raised temperature above room temperature.

Clause 157. The method of clause 155, wherein a first raised temperature above room temperature is between about 75° C. and about 150° C.

Clause 158. The method of clause 155, wherein a first raised temperature above room temperature is between about 90° C. and about 120° C.

Clause 159. The method of clause 156, wherein a second raised temperature above room temperature is between about 125° C. and about 200° C.

Clause 160. The method of clause 156, wherein a second raised temperature above room temperature is between about 150° C. and about 170° C.

Clause 161. The method of any one of clauses 134 to 160, wherein the initial precursor silicone resin mixture further comprises a photoinitiator and/or a thermal initiator.

Clause 162. The method of any one of clauses 134 to 161, wherein the modulus is selected from Young's modulus (E), shear modulus or modulus of rigidity (G), and bulk modulus (K).

Clause 163. The method of any one of clauses 134 to 161, wherein the modulus is storage modulus and/or loss modulus.

Clause 164. The method of any one of clauses 134 to 163, wherein a first portion of the precursor resin is exposed to the first polymerization and/or crosslinking stimulus, and a second portion of the precursor resin is shielded from the first polymerization and/or crosslinking stimulus.

Clause 165. The method of any one of clauses 134 to 163, wherein a first portion of the precursor resin is exposed to a first dosage of the first polymerization and/or crosslinking stimulus, and a second portion of the precursor resin is exposed to a second dosage of the first polymerization and/or crosslinking stimulus, wherein the first dosage and the second dosage are different.

Clause 166. The method of any one of clauses 134 to 165, wherein the method is a 3D printing method.

Clause 167. A silicone material having at least one modulus gradient in a spatial direction, the silicone material made by a method of any one of clauses 134 to 166.

Clause 168. A device comprising the silicone material of any one of clauses 101 to 133. In some embodiments, the devices is selected from a head-wearable device (e.g., a virtual-reality headset, smart glasses, augmented-reality glasses), a wrist-wearable device (e.g., a smartwatch), a smart textile-based garment, a haptic feedback device (e.g., a haptic display), a biomedical device, and/or other consumer devices.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software, or any combination thereof.

### EXAMPLES

Many applications would benefit from the ability to locally pattern the mechanical response to deformation. Such applications include soft robots, haptic displays, electronics substrates and packaging, and biomedical devices, Silicones are polymer classes well suited for these applications owing to their biocompatibility, high elasticity, as well as chemical and thermal resistance. Currently there are no ways to pattern continuous mechanical gradients that are stable in silicone. The next best method would be to assemble discrete steps of different modulus silicones, but that method encounters issue with mass deposition at sub mm scale and strong interfacial bonding between different materials.

At minimum the resin contains the following species: a multifunctional vinyl (vinyl ether, allyl, allyl ether, vinyl pyridinium, etc.) silicone, a thiol (mercaptopropyl, etc.) silicone, and a epoxide silicone, optionally a photoinitiator, and optionally a thermal initiator. In some embodiments, resins have a relatively large effective functionality of the vinyl species is large, e.g., 4 to 500, and a relatively smaller effective functionality of the thiol and epoxide species, e.g., 1.9 to 4, e.g., close to 2. Without wishing to be bound by any particular theory, this composition is beneficial for a few non-limiting reasons: the highly functional vinyl species lowers the critical conversion for gelation and maximizes gel fraction; dithiol and diepoxide species enhance the ratio of moduli between soft and stiff materials as these materials form a linear polymer (no crosslinks) during the second stage while any remaining diepoxide forms 2 crosslinks in the final stage.

Exemplary highly functional vinyl silicones: VDT-5035, VDT-954, VDT-731, VDT-431, VMS-T11 (Gelest). Exemplary dithiol silicones: X-22-167C, X-22-167B (Shin Etsui), 3-[(dimethyl-3-(sulfanylpropyl)silyl)oxy-dimethylsilyl]propane-1-thiol (DMSV03SH), mercaptopropyl terminated polydimethylsiloxane (DMSV05SH, MWT ˜870), SMS-042. Exemplary diepoxide silicones: DMS-E09, DMS-E11, DMS-E12, DMS-E21 (Gelest), EP-J10. Table 1 provides exemplary resin mixtures and storage moduli thereof as measured by tensile DMA at 1 Hz.

Table 1. Exemplary resin mixtures and storage moduli thereof as measured by tensile DMA at 1 Hz.

TABLE 1
Exemplary resin mixtures and storage moduli thereof as measured by tensile DMA at 1 Hz.

| | | | Mass | Mass | Mass | E′ | E′ | |
|---|---|---|---|---|---|---|---|---|
| | | | fraction | fraction | fraction | Max | Min | |
| Vinyl | Thiol | Epoxide | vinyl | thiol | epoxide | (MPa) | (MPa) | E′/E′ |
| VDT-731 | X-22-167C | DMS-E09 | 0.29 | 0.66 | 0.05 | 2.37 | 0.05 | 47.4 |
| VDT-5035 | X-22-167C | DMS-E09 | 0.06 | 0.87 | 0.07 | 3.11 | 0.28 | 11.1 |
| VDT-954 | X-22-167C | DMS-E09 | 0.25 | 0.7 | 0.06 | 2.4 | 0.29 | 8.3 |
| VDT-431 | X-22-167C | DMS-E09 | 0.4 | 0.55 | 0.04 | 1.81 | 0.03 | 60.3 |
| VDT-731 | X-22-167C | EP-J10 | 0.24 | 0.54 | 0.22 | 2.28 | 1.2 | 1.9 |
| VDT-731 | X-22-167C | DMS-E21 | 0.17 | 0.39 | 0.43 | 0.97 | 0.4 | 2.4 |
| VDT-731 | X-22-167C | DMS-E12 | 0.26 | 0.59 | 0.15 | 1.64 | 0.31 | 5.3 |
| VDT-731 | X-22-167C | 90% DMSE12, | 0.26 | 0.58 | 0.16 | 1.83 | 0.35 | 5.2 |
| | | 10% EPJ10 | | | | | | |
| VDT-731 | X-22-167C | 75% DMSE12, | 0.25 | 0.58 | 0.17 | 1.82 | 0.46 | 4 |
| | | 25% EPJ10 | | | | | | |
| VDT-731 | X-22-167C | 50% DMSE12, | 0.25 | 0.57 | 0.18 | 1.98 | 0.46 | 4.3 |
| | | 50% EPJ10 | | | | | | |
| VDT-731 | SMS-042 | DMSE09 | 0.34 | 0.6 | 0.06 | 3.98 | 1.58 | 2.5 |
| VDT-731 | X-22-167C | DMS-E11 | 0.28 | 0.64 | 0.08 | 1.84 | 0.8 | 2.3 |
| VDT-731 | DMSV03SH | DMS-E09 | 0.68 | 0.19 | 0.12 | 6.54 | 1.49 | 4.4 |
| VDT-954 | DMSV03SH | DMS-E09 | 0.63 | 0.22 | 0.14 | 7.57 | 0.93 | 8.1 |
| VDT-5035 | DMSV03SH | DMS-E09 | 0.26 | 0.45 | 0.29 | 38.07 | 0.52 | 73.2 |
| VDT-431 | DMSV03SH | DMS-E09 | 0.78 | 0.13 | 0.09 | 3.52 | 1.23 | 2.9 |
| VMS-T11 | DMSV03SH | DMS-E09 | 0.18 | 0.5 | 0.32 | 25.2 | 0.66 | 38.2 |

In some embodiments, to create a multimodulus sample, the resin is exposed to different cumulative photodosages of UV light. The amount of photodosage controls the extent of the thiol-ene photoreaction (x). The material is then heated to initiate the second stage, thiol-epoxy reaction (usually 105° C., for 8 h). This consumes all the remaining thiols (1-x) while also consuming an equimolar amount of epoxides (1-x). The resin is then heated at a higher temperature (150-170° C. for 8 h) to have the remaining epoxides (x) self-react. As a result of this staging and the differential crosslinking reactions, the final part will have local moduli (E) that depend on the initial photodosage and photoconversion (x) allowing for photopatterning of mechanical properties.

In some embodiments, the technology would apply to body worn wearables. All multimodulus materials form these blends possess glass transition temperatures below −80° C. (e.g., it doesn't stiffen or become brittle until below this temperature) and degradation temperatures above 200° C., which suggests robust thermo-mechanical stability necessary for environmentally exposed devices. Silicones are also dielectric materials and elastomers. This chemistry is adept at patterning in rigid/soft islands as a substrate to protect electronic components (chips) in stretchable electronic devices. Such stiffness patterning can prevent fragile electrical components from undergoing strain or debonding in stretchable applications. Further, most electronic components are adhered to conventional flex electronic substrates (e.g., Kapton) with epoxy adhesives. The latent 2nd and 3rd stages described herein permit a strong bond between such adhesives and the elastomeric film, something which is impossible when using COTS liquid silicone rubbers as a substrate.

1. A silicone material having a modulus gradient over one spatial direction, wherein modulus is measured in a plurality of voxels, the material comprising a partially or fully polymerized or crosslinked silicone resin.

2. The silicone material of claim 1, wherein the modulus is selected from Young's modulus (E), shear modulus or modulus of rigidity (G), and bulk modulus (K).

3. The silicone material of claim 1, wherein the modulus is storage modulus and/or loss modulus.

4. The silicone material of claim 1, wherein the modulus ranges from about 10² to about 10¹⁰ Pa.

5. The silicone material of claim 1, wherein the silicone material comprises a polymer backbone comprising a group selected from —Si(CH₃)₂—, —O—Si(CH₃)₂—, and —O—(CH₂)ₙ-, wherein n is integer from 1 to 3, from 4 to 6, or from 7 to 12.

6. The silicone material of claim 1, wherein the silicone resin comprises a polymer backbone comprising a group selected from —Si(CH₃)₂—, —O—Si(CH₃)₂—, and —O—(CH₂)ₙ-, wherein n is integer from 1 to 3, from 4 to 6, or from 7 to 12.

7. The silicone material of claim 1, wherein the silicone resin prior to polymerization and/or crosslinking comprises three different polymerizable or crosslinkable moieties.

8. The silicone material of claim 7, wherein the stoichiometric ratio of three different polymerizable or crosslinkable moieties is 1:X:Y, wherein X<1, and X+Y≥1.

9. The silicone material of claim 7, wherein the three different polymerizable or crosslinkable moieties are an alkene group, a thiol group, and an epoxy group.

10. The silicone material of claim 9, wherein the stoichiometric ratio of thiol groups to alkene groups to epoxy groups is 1:X:Y, wherein X<1, and X+Y≥1.

11. The silicone material of claim 1, wherein the silicone resin comprises a multifunctional vinyl or ene silicone, a multifunctional epoxide silicone, and a multifunctional thiol silicone.

12. The silicone material of claim 11, wherein the multifunctional vinyl or ene silicone has a functionality between about 4 and about 500.

13. The silicone material of claim 11, wherein the multifunctional epoxide silicone has a functionality between about 1.9 and about 4.

14. The silicone material of claim 11, wherein the multifunctional thiol silicone has a functionality between about 1.9 and about 4.

15. The silicone material of claim 1, wherein the silicone resin comprises a multifunctional vinyl or ene silicone, a diepoxide silicone, and a dithiol silicone.

16. The silicone material of claim 1, wherein the silicone material comprises at least one group selected from —S—, —S—CH₂—CH₂—, —S—CH₂—CH(OH)—, —CH₂—CH(−)—O—, and —CH₂ -CH(−)—O—CH₂—CH(OH)—.

17. The silicone material of claim 1, wherein the silicone material comprises a thiol-vinyl or thiol-ene adduct moiety, a thiol-epoxy adduct moiety, an alcohol-epoxy adduct moiety, and/or an epoxy-epoxy adduct moiety.

18. The silicone material of claim 1, wherein the silicone resin further comprises a photoinitiator and/or a thermal initiator.

19. A device comprising the silicone material of claim 1.

20. A method of generating a modulus gradient in a silicone material, the method comprising:
subjecting an initial precursor silicone resin mixture to a first polymerization and/or crosslinking stimulus, wherein the initial precursor silicone resin mixture comprises a plurality of monomers, polymers, or oligomers comprising at least three different polymerizable or crosslinkable moieties, wherein the at least three different polymerizable or crosslinkable moieties are selected from an alkene group, a thiol group, and an epoxy group,
generating an intermediate silicone resin mixture, and
subjecting the intermediate silicone resin mixture to a second polymerization and/or crosslinking stimulus.
